(19) United States
(12) Patent Application Publication
(10) Pub. No.: US 2003/0153202 A1
(43) Pub. Date: Aug. 14, 2003

(54) Card connector

(76) Inventor: Ryozo Koyama, Tokyo (JP)

Correspondence Address: KANESAKA & TAKEUCHI, 1423 Powhatan Street, Alexandria, VA, 22314, US

(21) Appl. No.: 10/291,639

(22) Filed: Nov. 12, 2002

(30) Foreign Application Priority Data
Nov. 12, 2001 (JP) 2001-346337

(51) Int. Cl. H01R 12/00

(52) U.S. Cl. 439/79

(57) ABSTRACT

It is difficult to insert shield members into spaces between signal terminals when the dimension of the spaces becomes small for the requirement of multi-signal, high-density mounting.

[Measures for Solution]

The signal terminals 21 and the ground terminal leads 22 are made by punching a metal plate and integrally molding them with the mold 23. The first and second contact portions 22a and 22b are provided on the ground terminal lead 22. The cavity 26 and the terminal apertures 27 are provided in the face of the mold 23. The first contact portions 22a project from the cavity 26 to the outside of the face and the second contact portions 22b project from the terminal apertures 27 to the outside of the face so that the first and second contact portions 22a and 22b are brought into contact with the vertical shield members 30 to make ground terminals. contact portions projects to said outside of said face so that said one and said other of said pair of contact portions are brought into contact with said shield member.

### DETAILED DESCRIPTION OF THE INVENTION

1. Field of the Invention

This invention relates to an electrical connector for high-speed transmission which is used to electrically connect a motherboard and a daughtercard.

2. Description of the Related Art

As the high-speed transmission of signals and the high-density mount on a board are required in the field of communication equipment and computers, there is a demand for an electrical connector enabling multi-signal high-speed transmission between boards.

A conventional electrical connector for high-speed transmission is disclosed in Japanese Patent Application Kokai number 2001-6820. In FIG. 17, signal terminals 92 and ground terminals 93 having the same shape as that of the signal terminals are alternately arranged in terminal holding cavities 91 provided in an insulative housing 90 such that the ground terminals 93 are positioned around the signal terminals 92 to use the adjacent signal terminals as ground terminals.

In such a conventional electrical connector, a plurality of signal terminals are arranged in a grille shape and shield members are provided between the signal terminals to transmit high-speed signals. Such a conventional art is disclosed in, for example, U.S. Pat. No. 6,213,91B1.

In FIG. 18, a receptacle 50 according to the conventional electrical connector for high-speed transmission comprises an insulative housing 51, a plurality of terminal blocks 60, and a plurality of horizontal shield members 80.

The insulative housing 51 has a plurality of signal terminal holding cavities (not shown) at a front portion thereof. The terminal block 60 comprises a block body 63 which is made by integrally forming a plurality of signal terminals 61 with a mold 62, and a vertical shield member 70. The block body 63 has an opening 64 from which signal terminal lead sections 61A project. The vertical shield member 70 has a plurality of curved shield plate insertion slits 71 at positions corresponding to positions between the signal terminal lead sections 61A.

The vertical shield member 70 is attached to the block body 63 to constitute the terminal block 60. The shield plate insertion slots 71 are opposed to spaces between the signal terminal lead sections 61A in the opening 64. Horizontal shield member 80 is made of a metal plate having the same shape as that of the curved shield plate insertion slit 71.

The signal terminals 61 of the terminal block 60 are inserted into signal terminal holding holes in the insulative housing 51. Thus, a plurality of the terminal blocks are attached to the insulative housing 51. The horizontal shield members 80 are inserted from the shield plate insertion slits 71 into the spaces between the signal terminal lead sections 61A in the opening 64 so that the signal terminals 61 are surrounded by the vertical and horizontal shield members 70 and 80. Thus, the receptacle 50 is constructed.

### PROBLEMS TO BE SOLVED BY THE INVENTION

In the first conventional electrical connector disclosed in Japanese Patent Application number 2001-6820, the signal terminals 92 are surrounded by the ground terminals 93 having the same shape as that of the signal terminals 93 and the adjacent signal terminals 92 are used as the ground terminals 93. Consequently, it is impossible to increase the signal density and achieve the multi-signal high-density mounting.

In the second conventional electrical connector disclosed in U.S. Pat. No. 6,213,91B1, the horizontal shield members 80 are inserted between the signal terminals 61 to provide a shield between the signal terminals 61. However, the dimension between the signal terminals is required to be small for the multi-signal high-density mounting for en electrical connector for high-speed transmission.

When the dimension between the signal terminals becomes small, it increases the manufacturing cost because of the assembly work to insert the horizontal shield members 80 between the signal terminals 61.

Accordingly, an object of the invention is to provide an electrical connector for high-speed transmission to control the cross talk between the signal terminals and achieve the multi-signal high-density mounting.

### MEASURES TO SOLVE THE PROBLEMS

An electrical connector for high-speed transmission comprises at least one terminal block, wherein the terminal block includes a plurality of signal terminals, each having a signal terminal lead and at least one contact portion brought into contact with a mating signal terminal, a plurality of ground terminals, each having a ground terminal lead arranged substantially in parallel to and alternately with the signal terminal lead, and a shield member having at least one contact portion brought into contact with a mating ground terminal, wherein the ground terminal lead is brought into contact with the shield member.

Since the ground terminal leads, which are arranged substantially in parallel to and alternately with the signal terminal leads, are brought into contact with the shield members to make ground terminals, the cross talk between the signal terminals is controlled and the multi-signal, high-density mounting is achieved.

The signal terminals and said ground terminal leads are made by punching a metal plate and integrating them with a mold and the shield member is attached to the mold.

Since the signal terminals and the ground terminal leads are made by punching the metal plate and integrally forming them with the mold such that the ground terminal leads are arranged substantially in parallel to and alternately with the signal terminal leads, it is not necessary to use separate shield members, resulting in the reduction of the manufacturing cost.

Each of the ground terminal leads has a pair of contact portions projecting from a face of the mold to be brought into contact with the shield member.

Accordingly, even if the ground terminal is composed of two separate members, that is, the ground terminal lead and the shield member, the ground terminal and the shield member are easily and firmly brought into contact with each other.

The pair of contact portions are provided at opposed ends of the ground terminal lead and the face of the mold has a cavity from which one of the pair of contact portions projects to an outside of the face and a terminal apertures from which the other of the pair of contact portions projects to the outside of the face so that the pair of contact portions are brought into contact with the shield member.

Accordingly, even if the ground terminal is composed of two separate members, that is, the ground terminal lead and the shield member, the ground terminal and the shield member are easily and firmly brought into contact with each other.

### EMBODIMENTS OF THE INVENTION

Embodiments of the invention will now be described with reference to the attached drawings.

FIG. 1 is a sectional view of ground terminals of an electrical connector for high-speed transmission according to the present invention in the condition before a header is coupled with a receptacle. FIG. 2 is a sectional view of the ground terminals in the condition after the header is coupled with the receptacle. FIG. 3 is a vertical sectional view of signal terminals of the electrical connector for high-speed transmission according to the present invention in the condition before the header is coupled with the receptacle. FIG. 4 is a vertical sectional view of the signal terminals in the condition after the header is coupled with the receptacle. FIG. 5 is a horizontal sectional view of the ground and signal terminals in the condition before the header is coupled with the receptacle. FIG. 6 is a horizontal sectional view of the ground after signal terminals in the condition after the header is coupled with the receptacle. The back-and-forth direction, right-and-left direction, and up-and-down directions are indicated in the drawings by arrows.

The electrical connector for high-speed transmission is composed of a receptacle 1 and a header (a plug) 2 which is detachably coupled with the receptacle 1.

In FIGS. 8 and 9, the receptacle 1 comprises an insulative housing 10 and a plurality of terminal blocks 20. Signal terminal cavities 11 and ground terminal cavities 12 are provided in the insulative housing 10 in line and row and column. That is, the signal terminal cavities 11 are provided in five rows in the up-and-down direction and in three columns in left-and-right direction, and the ground terminal cavities are provided in five rows in the up-and-down direction and in three columns in the left-and-right direction. Each signal terminal cavity 11 has a mating signal terminal insertion hole 11a and each ground terminal cavity 12 has a mating ground terminal insertion hole 12a. The mating signal and ground terminal insertion holes 11a and 12a are arranged in a zigzag fashion.

In FIG. 10, horizontal shield members 13 are buried in partition walls 14 between the signal terminal cavities in the up-and-down direction. Three contact pieces 13A are provided at a front top of the horizontal shield member 13 in the right-and-left direction and each contact piece 13A has a contact portion 13a (FIG. 8). The contact piece 13A projects to a front top of the ground terminal cavity 12.

A plurality of guide projections 10A are provided in upper and lower faces of the insulative housing 10 in the right-and-left direction at a predetermined interval. A plurality of terminal engagement portions 10B are provided on the upper face of the insulative housing 10 in the right-and-left direction at a predetermined interval.

The terminal block 20 comprises signal terminals 21, ground terminal leads 22, vertical shield members 30, and an outer ground terminal 33. The ground terminal leads 22 and vertical shield members 30 constitute ground terminals.

In FIG. 12, each signal terminal 21 comprises a fixed section 21A which is fixed in the signal terminal cavity 11, a flexible contact piece 21B which has a contact portion 21a to receive and contact with a contact portion 42a of a signal terminal 42 or a post-pin of a card B, a signal terminal lead section 21C which extends rearwardly from the fixed section 21A and bent in the same plane as that of the fixed section 21A, and a contact lead 21D which extends downwardly from the lead section 21C for contact with the card B.

The ground terminal leads 22 have the same shape as that of the signal terminal lead sections 21C and are arranged in parallel with the signal terminal sections 21C. In FIG. 13, the top of the ground terminal lead 22 is bent to provide a flexible contact piece 22A having a contact portion 22a as a first contact portion. A flexible contact piece 22B is provided at a lower part of the ground terminal lead 22 and has a contact portion 22b as a second contact portion (FIGS. 15 and 16).

That is, the signal terminals 21 and ground terminal leads 22 are formed from one metal plate by punching process. The fixed sections 21A and contact leads 21D of the signal terminals 21 are connected to a carrier 24 by connection sections 24C and 24A, respectively. The contact terminal leads 22 are also connected to the carrier 24 by contact sections 24B.

In FIG. 14, the signal terminals 21 and ground terminal leads 22 are integrally molded with a mold 23. The connection sections 24C and 24A are disconnected from the signal terminals 21, and the connection sections 24B are disconnected from the ground terminal leads 22.

A shield member attachment section 25 is provided on a side face of the mold 23. The shield member attachment section 25 has a cavity 26 elongated in the up-and-down direction in a front portion thereof and four terminal apertures 27 at a predetermined interval in the back-and-forth direction in a lower portion thereof.

The fixed sections 21A and the flexible contact pieces 21B of the signal terminals 21 project forwardly from a front face 23a of the mold 23. The flexible contact pieces 22A of the ground terminal leads 22 project from the cavity 26 to the outside of a face 25a of the shield member attachment section 25, and the contact sections 21D of the signal terminals 21 project downwardly from a lower face 23b of the mold 23. The flexible contact pieces 22B of the ground terminal leads 22 are bent into the terminal apertures 27, and the contact portions 22b of the flexible contact pieces 22B project outwardly from the face 25a of the shield member attachment section 25.

In FIG. 16, the vertical shield member 30 is a rectangular plate and comprises a plurality (five in FIG. 16) of contact pieces 30A provided at a front edge thereof at a predetermined interval in the up-and-down direction and a plurality (four in FIG. 16) of contact pieces 30B at a lower edge thereof at a predetermined interval in the back-and-for the direction.

The vertical shield member 30 is attached to the shield member attachment section 25 and brought into contact with the contact portions 22a and 22b of the flexible contact pieces 22A and 22B of the ground terminal leads 22.

In FIG. 8, the outer ground terminal 33 is fixed to an upper face 23c and a rear face 23d of the mold 23, and contact pieces 33A and contact leads 33D of the outer ground terminal 33 are arranged in parallel with the contact pieces 30A and 30B, respectively. A contact portion 33a of the outer ground terminal 33 is in contact with the vertical shield member 30.

The fixed sections 21A of the signal terminals 21 are inserted into the signal terminal cavities 11, and the contact pieces 30A of the vertical shield members 30 are inserted into the ground terminal cavities 12, so that the terminal block is mounted into the insulative housing 10. As shown in FIG. 1, the contact piece 33A of the outer ground terminal 33 engages with the terminal engagement portion 10B provided on an upper face of the insulative housing 10. The insulative housing 10 is used as a plugging section 34 of the receptacle 1.

The receptacle 1 is made by mounting a plurality of terminal blocks 20 into the insulative housing 10 in such a way as described above. As shown in FIG. 10, the vertical shield members 30 are provided between adjacent signal terminals 21 in the right-and-left direction and the horizontal shield members 13 are provided between the adjacent signal terminals 21 in the up-and-down direction, thus the signal terminals 21 are surrounded by the vertical and horizontal shield members 30 and 13. By making a para-coaxial structure where the signal terminals 21 are surrounded by the vertical and horizontal shield members 30 and 13, the adjustment of impedance and the control of cross talk are efficiently made.

In FIGS. 1 and 3, the contact leads 21D of the signal terminals 21, the contact pieces 30B of the vertical shield members 30, and the contact leads 33D of the outer ground terminal 33 are inserted into through-holes (not shown) of a daughter card A and soldered so that the receptacle 1 is mounted on the daughter card A.

A C-shaped header body 2A of the header (plug) 2 have an end wall 2a, an upper wall 2b, and a lower wall 2c defining a plugging cavity 40. A plurality of guide channels 41 extending in the insertion direction into the receptacle 1 are provided in the inside surfaces of the upper and lower walls 2b and 2c at a predetermined interval in the right-and-left direction.

A plurality of header signal terminals 42 and header ground terminals 43 are provided in the end wall 2a in row and column in a zigzag-fashion corresponding to the mating signal terminal insertion holes 11a of the signal terminal cavities 11 and the ground terminal insertion holes 12a of the ground terminal cavities 12, respectively. Contact portions 42a and 43a of the header signal and ground terminals 42 and 43 project into the plugging cavity 40 and contact leads 42b and 43b of the header signal and ground terminals 42 and 43 project into the outside of the end wall 2a.

Header ground terminals 44 is provided at an upper portion of the end wall 2a at a predetermined interval in the right-and-left direction. Contact portions 44 of the header ground terminals 44 project into the plugging cavity 40 and contact leads 44b of the header ground terminals 44 project into the outside of the end wall 2a.

In FIGS. 1 and 3, the contact leads 42b of the header signal terminals 42 and the contact leads 43b and 44b of the header ground terminals 43 and 44 are inserted into through-holes (not shown) of a mother board B and soldered so that the header 2 is mounted on the mother board B.

How to plug and unplug the receptacle 1 and header 2 will now be described.

In FIGS. 2, 4, and 6, the plugging section 34 of the receptacle 1 is plugged into the plugging cavity 40 of the header 2 mounted on the motherboard B. The guide projections 10A are inserted into the guide channels 41 so that the plugging section 34 is plugged into the plugging cavity 40 smoothly.

When the plugging section 34 is plugged into the plugging cavity 40, the contact portions 42a of the header signal terminals 42 are brought into contact with the contact portions 21a of the flexible contact pieces 21B of the signal terminals 21. In FIG. 2, the contact portions 43a of the header ground terminals 43 are inserted between the contact pieces 13A and 30A of the horizontal and vertical shield members 13 and 30 and brought into contact with the contact pieces 13A and 30A. The contact portion 44a of the header ground terminal 44 is brought into contact with the contact piece 33A of the outer ground terminal 33. Thus, the receptacle 1 and the header 2 are plugged.

In order to unplug the receptacle 1 from the header 2, the plugging section 34 is pulled out from the plugging cavity 40. The contact portions 43a of the header ground terminals 43 are pulled out from the space between the contact pieces 13A and 30A of the horizontal and vertical shield members 13 and 30 so that the contact between the contact portions 43a and the contact pieces 13A and 30A is released. Also, the contact portion 44a of the header ground terminal 44 is separated from the contact piece 33A of the outer ground terminal 33.

According to the embodiment of the invention, the signal terminals 21 and the ground terminal leads 22 are made by punching a metal plate and integrally molding them with the mold 23. The first and second contact portions 22a and 22b are provided on the ground terminal lead 22. The cavity 26 and the terminal apertures 27 are provided in the face of the mold 23. The first contact portions 22a project from the cavity 26 to the outside of the face and the second contact portions 22b project from the terminal apertures 27 to the outside of the face so that the first and second contact portions 22a and 22b are brought into contact with the vertical shield members 30. Consequently, shielding can be provided between the signal terminals 21 even if the dimension between the signal terminals 21 is small. As a result, the cross talk between the signal terminals is controlled and the multi-signal high-density mounting is achieved.

Since the signal terminals 21 and the ground terminal leads 22 are made by punching a metal plate and integrally molding them with the mold 23, it is possible to dispose the ground terminal leads 22 between the signal terminals 21. Consequently, a separate shield member is not required, resulting in the reduction of the manufacturing cost.

Since the first contact portions 22a project from the cavity 26 to the outside of the face of the mold 23 and the second contact portions 22b project from the terminal apertures 27 to the outside of the face so that the first and second contact portions 22a and 22b are brought into contact with the vertical shield members 30, the ground terminal leads 22 and the vertical shield members 30 are easily and firmly brought into contact with each other to make ground terminals.

### EFFECTS OF THE INVENTION

According to the electric connector for high-speed transmission of the invention, the ground terminal leads, which are arranged substantially in parallel to and alternately with the signal terminal leads, are brought into contact with the shield members to make ground terminals. Consequently, the cross talk between the signal terminals is controlled and the multi-signal, high-density mounting is achieved.

Also, the signal terminals and the ground terminal leads are made by punching a metal plate and integrally forming them with the mold such that the ground terminal leads are arranged substantially in parallel to and alternately with the signal terminal leads. Consequently, it is not necessary to use the separate shield members, resulting in the reduction of the manufacturing cost.

In addition, even if the ground terminal is composed of two separate members, that is, the ground terminal lead and the shield member, the ground terminal and the shield member are easily and firmly brought into contact with each other.

### BRIEF DESCRIPTION OF THE DRAWINGS

FIG. 1 is a sectional view of ground terminals of an electrical connector for high-speed transmission according to the present invention in the condition before a header is coupled with a receptacle.

FIG. 2 is a sectional view of the ground terminals in the condition after the header is coupled with the receptacle.

FIG. 3 is a vertical sectional view of signal terminals of the electrical connector for high-speed transmission according to the present invention in the condition before the header is coupled with the receptacle.

FIG. 4 is a vertical sectional view of the signal terminals in the condition after the header is coupled with the receptacle.

FIG. 5 is a horizontal sectional view of the ground and signal terminals in the condition before the header is coupled with the receptacle.

FIG. 6 is a horizontal sectional view of the ground after signal terminals in the condition after the header is coupled with the receptacle.

FIG. 7 is a horizontal sectional view of the signal and ground terminals of the receptacle in an exploded condition.

FIG. 8 is a vertical sectional view of the ground terminals of the receptacle in an exploded condition.

FIG. 9 is a vertical sectional view of the signal terminals of the receptacle in an exploded condition.

FIG. 10 is a sectional view of FIG. 4 taken along the line X-X, partly omitted.

FIG. 11 is a sectional view of FIG. 4 taken along the line Y-Y, partly omitted.

FIG. 12 is a top plan view of a punched metal for the punched signal terminals and ground terminal leads of the receptacle.

FIG. 13 is a view of FIG. 12 from the Z direction.

FIG. 14 is a top plan view of the punched metal for the signal terminals and ground terminal leads showing the condition after being molded.

FIG. 15 is a top plan view of the punched metal for the signal terminals and ground terminal leads showing the condition after being molded and cut off from a carrier.

FIG. 16 is an exploded perspective view of a terminal block.

FIG. 17 is a vertical sectional view of a receptacle according to a conventional electrical connector for high-speed transmission.

FIG. 18 is an exploded perspective view of a receptacle according to another conventional electrical connector for high-speed transmission.

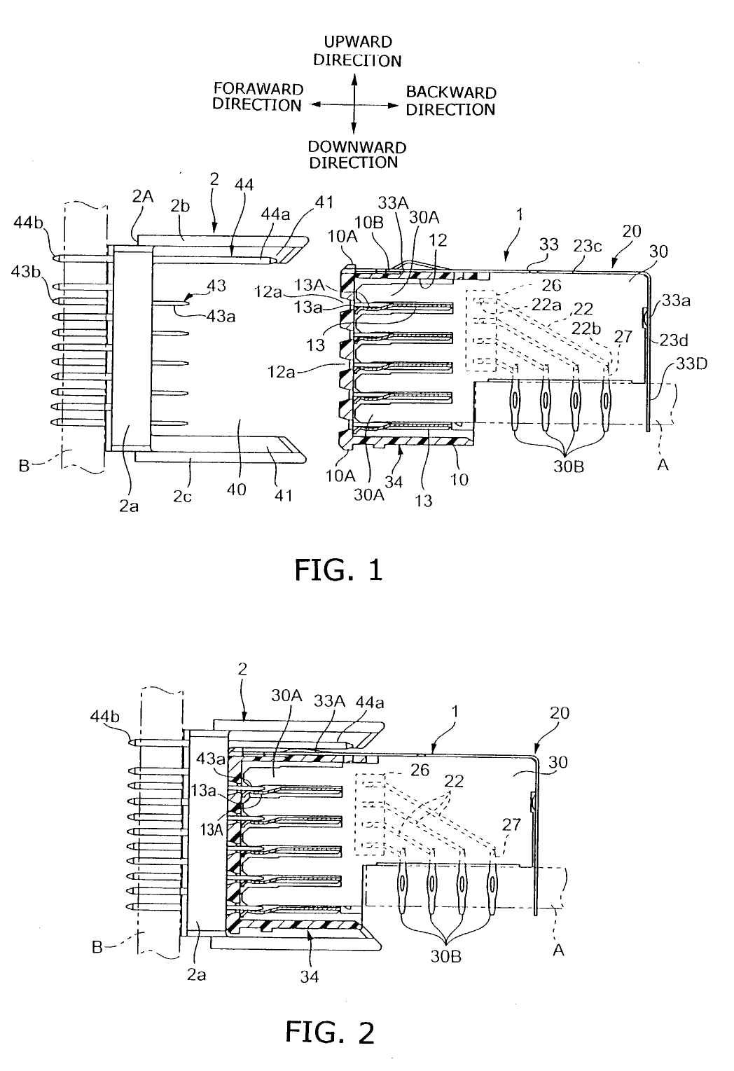

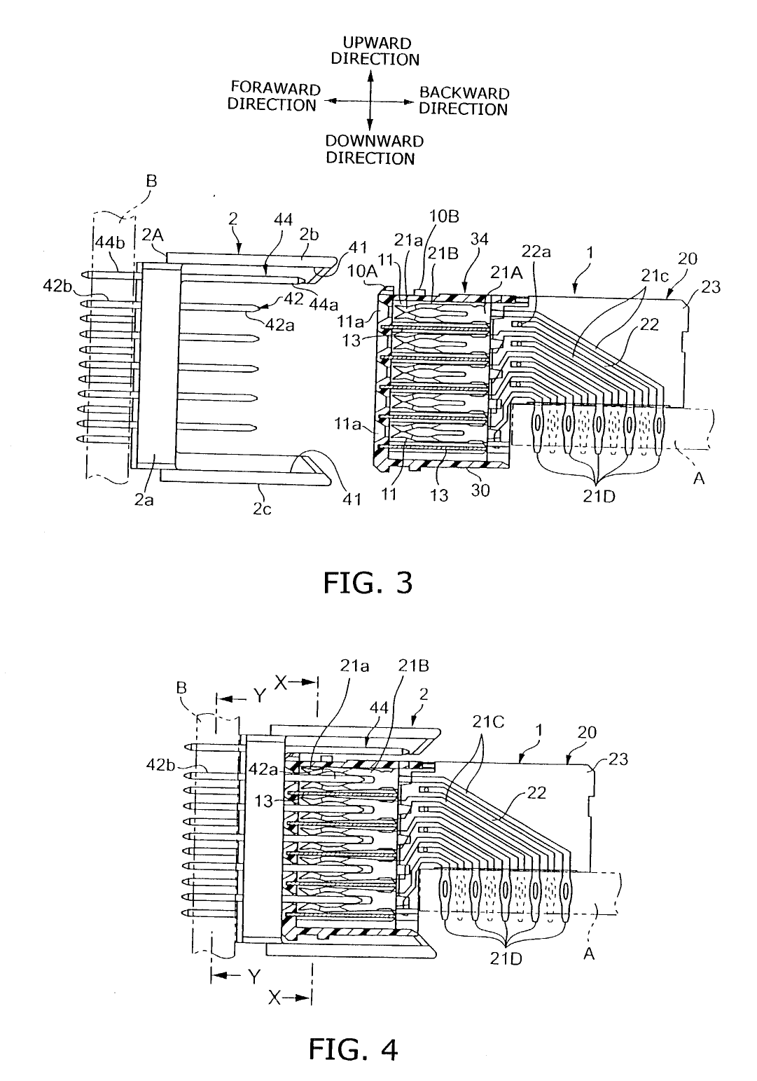

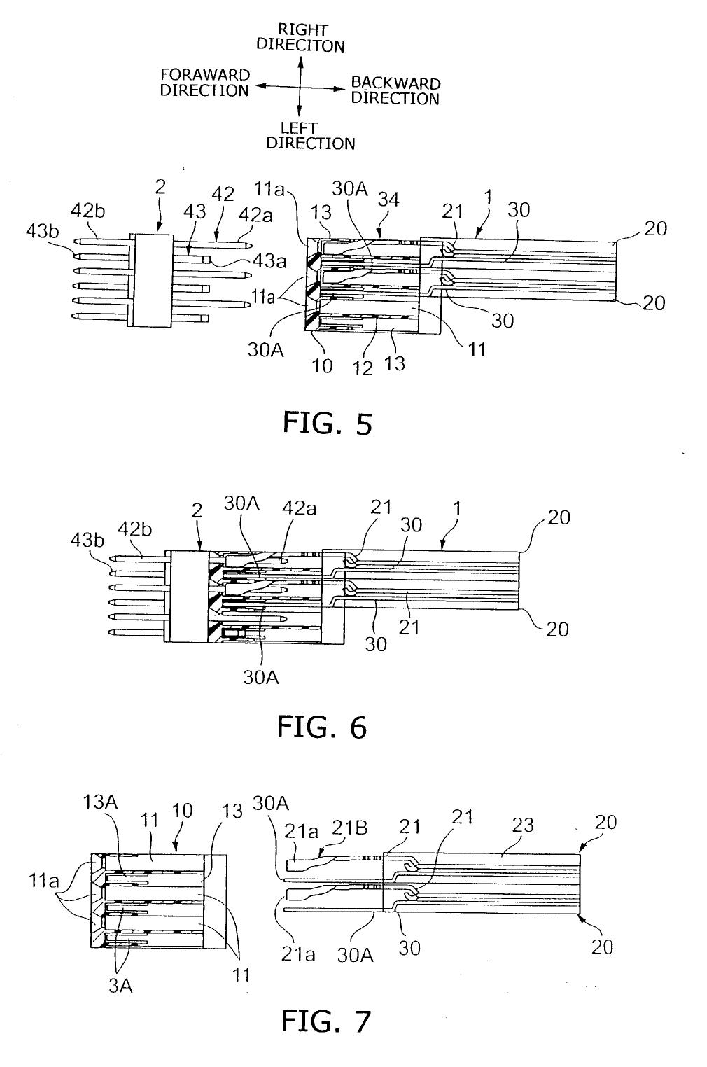

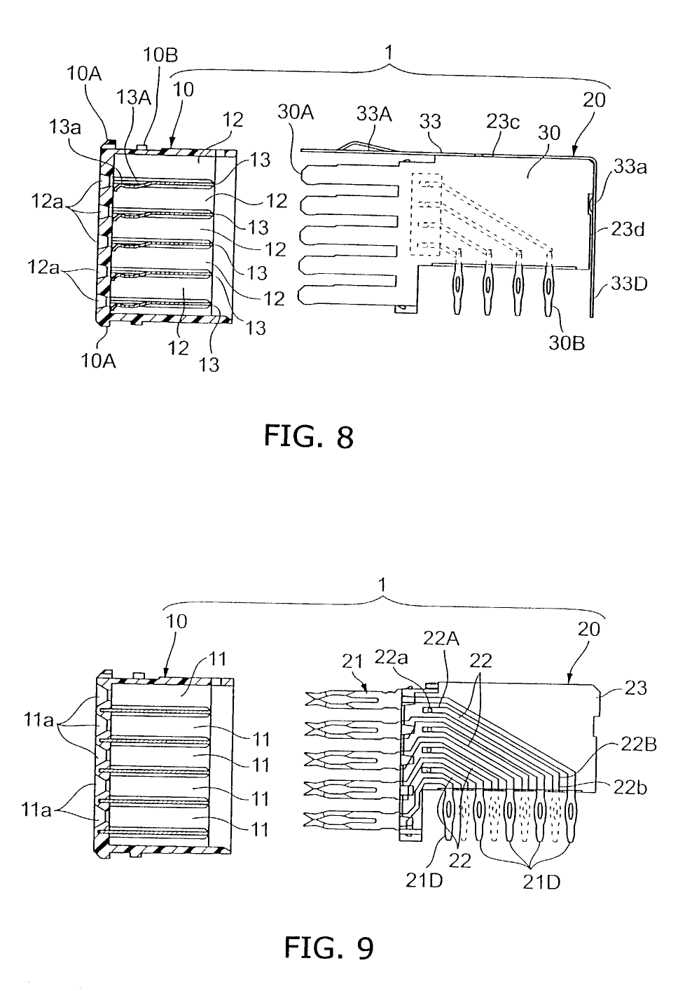

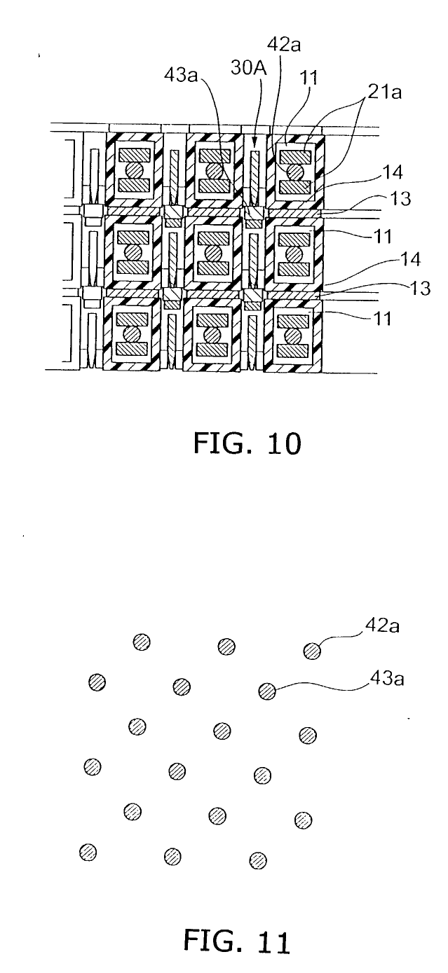

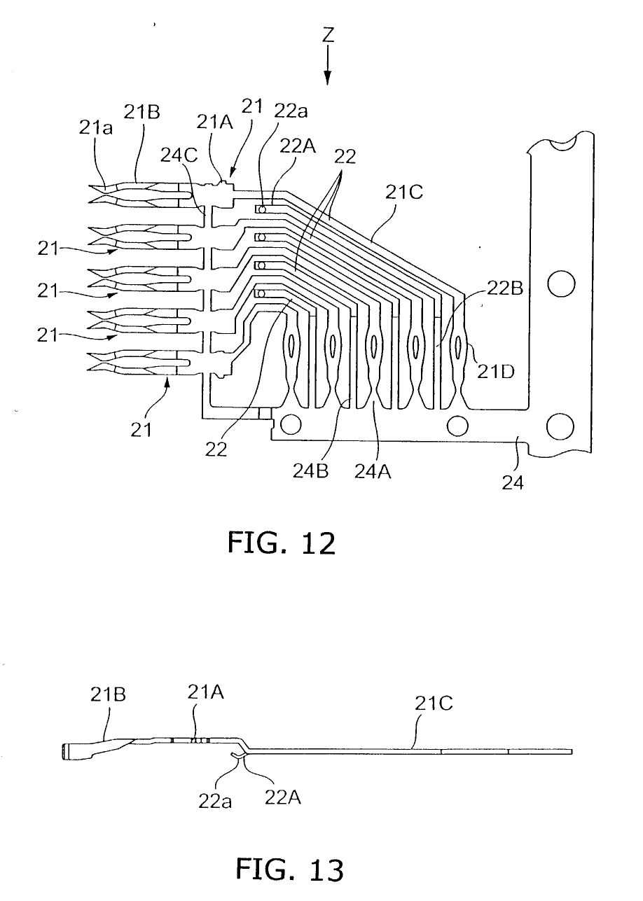

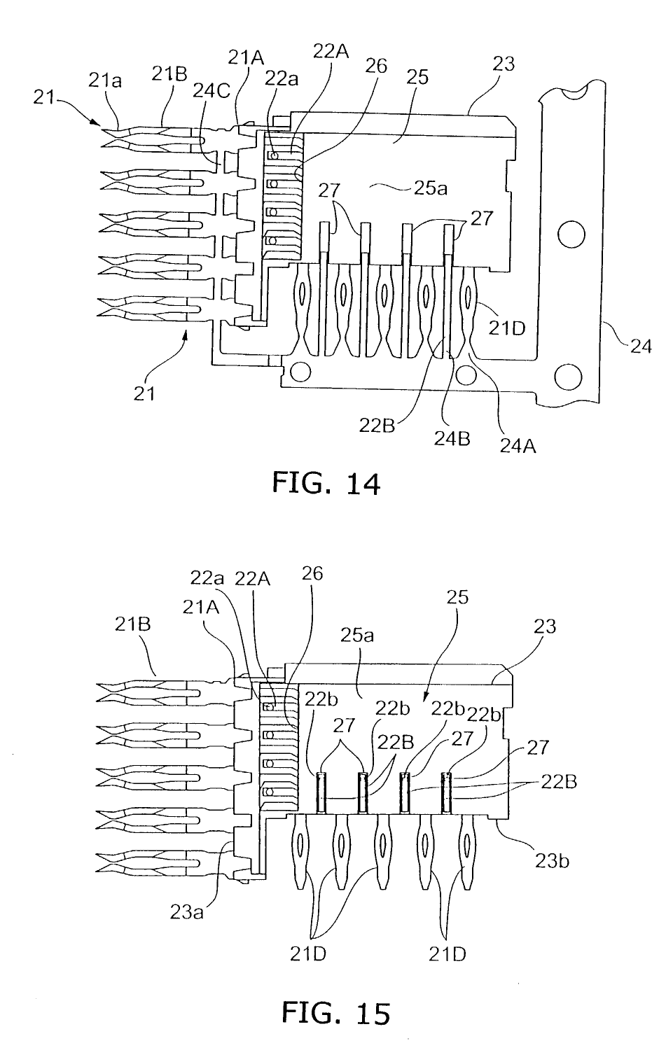

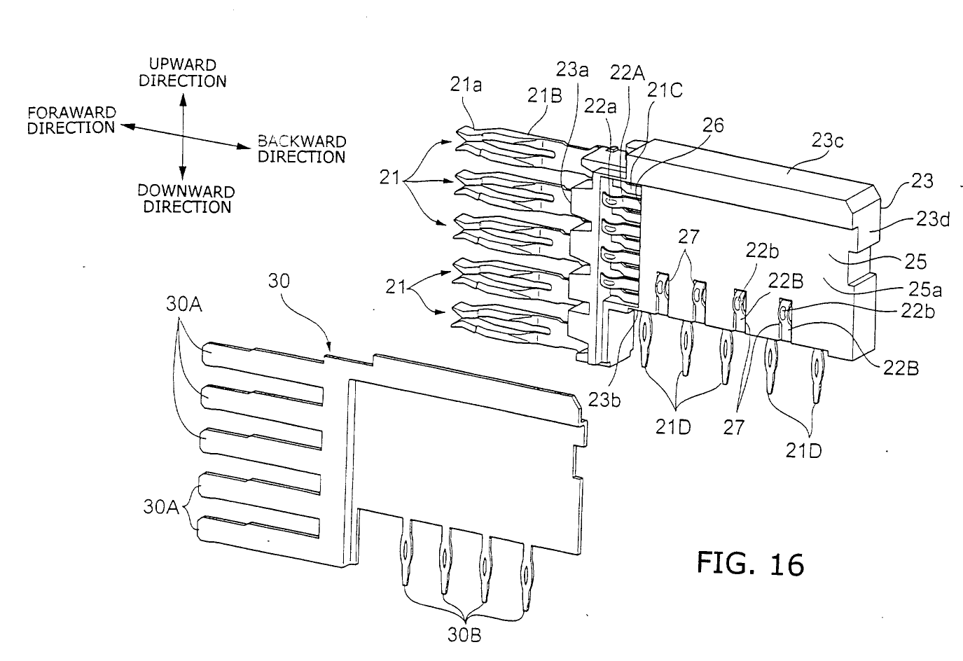

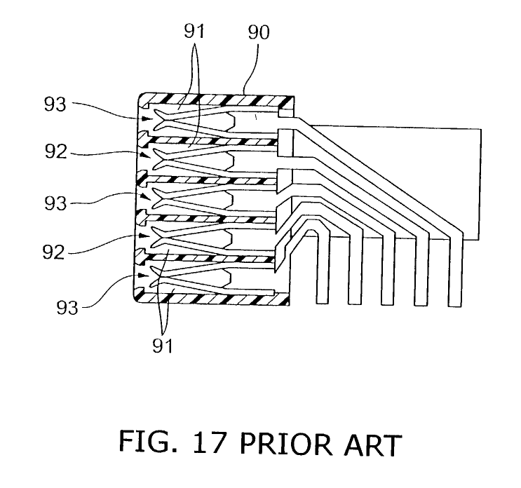

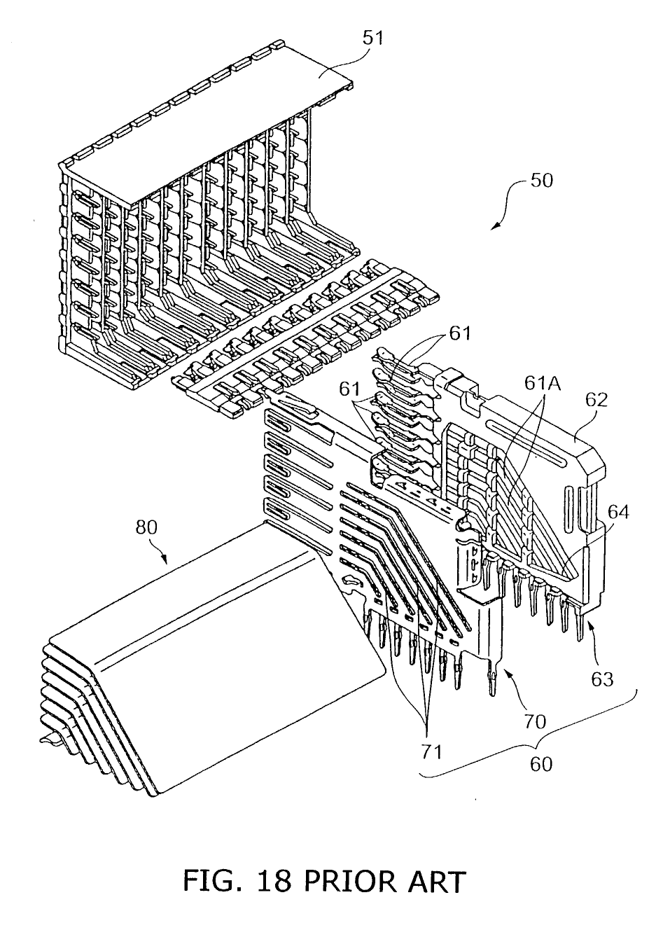

1. An electrical connector for high-speed transmission, comprising at least one terminal block, said terminal block including:
a plurality of signal terminals, each having a signal terminal lead and at least one contact portion brought into contact with a mating signal terminal;
a plurality of ground terminals, each having a ground terminal lead arranged substantially in parallel to and alternately with said signal terminal lead, and a shield member having at least one contact portion brought into contact with a mating ground terminal, said ground terminal lead being brought into contact with said shield member.

2. The electrical connector according to claim 1, wherein said signal terminals and said ground terminal leads are made by punching a metal plate and integrating them with a mold and said shield member is attached to said mold.

3. The electrical connector according to claim 2, wherein each of said ground terminal leads has a pair of contact portions projecting from a face of said mold to be brought into contact with said shield member.

4. The electrical connector according to claim 3, wherein said pair of contact portions are provided at opposed ends of said ground terminal lead and said face of said mold has a cavity from which one of said pair of contact portions projects to an outside of said face and a terminal apertures from which the other of said pair of contact portions projects to said outside of said face so that said one and said other of said pair of contact portions are brought into contact with said shield member.

1. An electrical connector for high-speed transmission, comprising at least one terminal block, said terminal block including:
a plurality of signal terminals, each having a signal terminal lead and at least one contact portion brought into contact with a mating signal terminal;
a plurality of ground terminals, each having a ground terminal lead arranged substantially in parallel to and alternately with said signal terminal lead, and a shield member having at least one contact portion brought into contact with a mating ground terminal, said ground terminal lead being brought into contact with said shield member.

2. The electrical connector according to claim 1, wherein said signal terminals and said ground terminal leads are made by punching a metal plate and integrating them with a mold and said shield member is attached to said mold.

3. The electrical connector according to claim 2, wherein each of said ground terminal leads has a pair of contact portions projecting from a face of said mold to be brought into contact with said shield member.

4. The electrical connector according to claim 3, wherein said pair of contact portions are provided at opposed ends of said ground terminal lead and said face of said mold has a cavity from which one of said pair of contact portions projects to an outside of said face and a terminal apertures from which the other of said pair of
